(19) United States
(12) Patent Application Publication
(10) Pub. No.: US 2018/0011976 A1
(43) Pub. Date: Jan. 11, 2018

(54) SELF-SERVICE HEALTHCARE PLATFORM

(71) Applicant: Amino, Inc., San Francisco, CA (US)

(72) Inventors: Kate M. Lewis, San Francisco, CA (US); Shashank Shekhar, San Francisco, CA (US); Farid Jamshidian, South San Francisco, CA (US); Timothy A. Tusing, Berkeley, CA (US)

(21) Appl. No.: 15/644,691

(22) Filed: Jul. 7, 2017

Related U.S. Application Data
(60) Provisional application No. 62/360,263, filed on Jul. 8, 2016.

(51) Int. Cl. G06F 19/00

(52) U.S. Cl. CPC G06F 19/328; G06F 19/324

(57) ABSTRACT

The disclosed embodiments include a self-service server computer that can be caused to obtain provider-patient data and provider-provider data. The obtained data is pre-process to extract service codes and parameter values associated with the service codes. The self-service server can generate a service episode including a target service and a plurality of ancillary services. The service episode has a parameter value estimated from a parameter value of a service code for the target service and a plurality of parameter values of service codes for the ancillary services. The self-service server can return the estimated parameter value of the service episode in response to a query for a parameter value of the target service such that the estimated parameter value is a proxy for the parameter value for the target service when the self-service server is queried for the target service.

### CROSS REFERENCE TO RELATED APPLICATION

This application claims the benefit of U.S. provisional patent application Ser. No. 62/360,263, filed Jul. 8, 2016, the entirety of which is incorporated herein by this reference thereto.

### TECHNICAL FIELD

The disclosed teachings relate generally to a self-service healthcare platform. Specifically, the self-service healthcare platform can estimate parameter values for queried services based on provider-patient and provider-provider data. An estimated parameter value is generated in a self-service process to facilitate identifying a service provider.

### BACKGROUND

Healthcare systems are complex. The elements of a healthcare system may include an organization of people, institutions, and/or resources to provision services. Patients face difficulties in making informed decisions. For example, accessibility to a service largely depends on the availability of a service provider (e.g., doctor) as well as limits on access to that service (e.g., medical procedure). A patient may desire to make informed decisions based on parameter values (e.g., cost) for a given service.

The availability and access to healthcare services can vary from provider to provider. Access to the same services by different patients may be different for reasons that are unknown to the patients or the service providers. This results in part because the basis for determining these parameter values for services is data that is incomplete or fragmented. As such, there is no single repository that can be queried by anyone for a response that can guide a patient to make informed decisions.

### BRIEF DESCRIPTION OF THE DRAWINGS

FIG. 1 is a block diagram illustrating a self-service healthcare platform according to some embodiments of the present disclosure;

FIG. 2 is a sequence diagram illustrating a process for estimating parameter values for services according to some embodiments of the present disclosure;

FIG. 3 is a flowchart that illustrates a process for estimating parameter values for target services according to some embodiments of the present disclosure;

FIG. 4A illustrates a self-service portal used to query estimate parameter values for a target service according to some embodiments of the present disclosure;

FIG. 4B illustrates a graphical user interface (GUI) view of the self-service portal used to constrain a query for estimate parameter values of target services to a particular geographical region according to some embodiments of the present disclosure;

FIG. 4C illustrates a GUI view used to further constrain the query for estimate parameter values of the target service to a particular insurance provider according to some embodiments of the present disclosure;

FIG. 4D illustrates a GUI view showing estimate costs for a particular service within a particular region covered by a particular insurance provider according to some embodiments of the present disclosure;

FIG. 4E illustrates a GUI view showing data for a particular insurance provider in the particular geographic region according to some embodiments of the present disclosure;

FIG. 4F illustrates a GUI view showing data for a personalized calculation of a parameter according to some embodiments of the present disclosure; and

FIG. 5 is a block diagram illustrating a computer operable to implement the disclosed technology according to some embodiments of the present disclosure.

### DETAILED DESCRIPTION

The embodiments set forth below represent the necessary information to enable those skilled in the art to practice the embodiments, and illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

As used herein, the term “service” may refer to a procedure, diagnoses, treatment, or the like, provisioned to a patient or tool that facilitates access by a patient to a procedure, diagnoses, treatment or the like. The service may be administered by a healthcare provider or act as an interface to facilitate access to a healthcare provider.

As used herein, the term “provider” may refer to an entity that provisions services to patients. Examples include a healthcare professional, organization, facility, insurer, computing resource, or the like. A “service provider” may refer specifically to a healthcare professional.

As used herein, the term “patient” may refer to a person who can be provisioned services from a provider. The term “user” refers to a person or machine that may interface with a service or provider.

The disclosed embodiments include a self-service healthcare platform (“self-service platform”) that can estimate parameter values in response to queries about services. In some embodiments, the parameter values reflect costs that insurance companies may be willing to pay for a given service on a per service provider basis. In some embodiments, the disclosed technology can use two types of data to estimate parameter values: (i) data indicative of patient-provider interactions and (ii) data indicative of provider-provider interactions. For example, claims records may include data indicative of patient-provider interactions, and payment records of insurance providers to healthcare professionals can include data indicative of provider-provider interactions.

The patient-provider interactions data and provider-provider interactions data are applied to service episodes as proxies to determine parameter values for patients services. A service episode includes a number of services. A target service may be defined by a service code, which can be indicative of a procedure for which a user seeks guided self-help. An ancillary service is a service ancillary to the target service. An ancillary service may be provisioned concurrently or consecutively with a target service. For example, patients can experience both a target service and an ancillary service at the same time or different time. The frequency of a particular ancillary service for a particular target service may differ per patient. As such, each service can be weighted by its frequency for a service episode having a target service.

A user can query the self-service platform for parameter values of a particular target service. The self-service platform estimates parameter values for a target service based on service episodes that include the target service and may include ancillary services. The estimated parameter values can be used to identify a suitable service provider satisfying certain user-selected constraints. For example, the self-service platform can estimate a cost for a procedure sought by a user. The cost can be estimated for an episode of care that includes the target procedure and ancillary procedures. As such, the user can query the self-service platform to estimate costs for a particular service on a per service provider basis.

The self-service platform may include an exploration tool that provides insights into parameters of services per provider and geographic area. For example, a user can input a query to a user interface of the exploration tool. The query may include a provider, service, or geographic location/region. In response to the query, the self-service platform estimates a parameter value such as a cost based on a model of a service episode that includes a target service and any ancillary services normalized by a frequency of services.

The self-service platform may include a tool for identifying relationships between a quality of service and parameter values. For example, the self-service platform can provide insights into the relationship between quality of care and cost of care. The self-service platform can cause display of query results on the user interface of a display of a client device. The raw query results may be presented or are further processed to generate a visualization indicative of the estimated values. For example, in response to querying for the cost of a procedure performed by a particular doctor, the self-service healthcare platform can provide information of a comparable doctor that charges less for the same procedure.

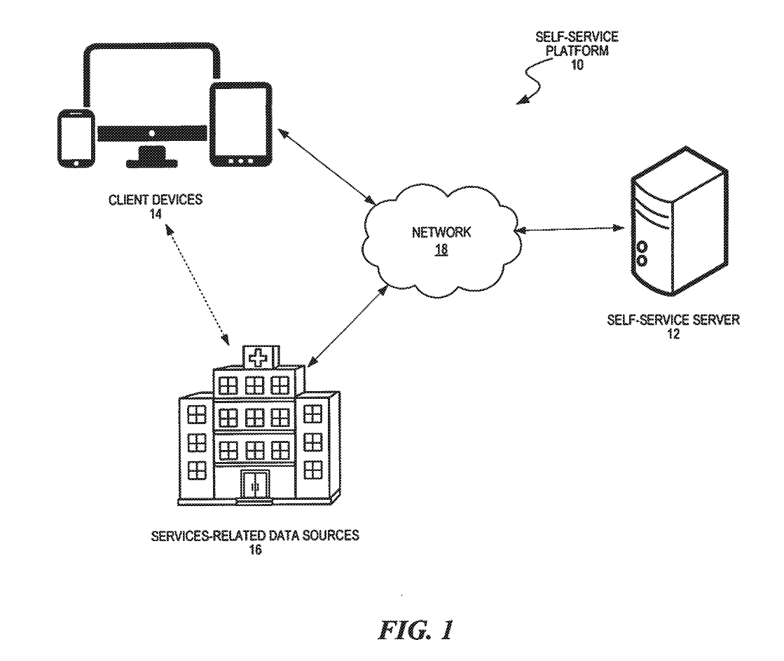

FIG. 1 is a block diagram of the self-service platform 10 (“platform 10”) operable to estimate parameter values for services according to some embodiments of the present disclosure. The platform 10 can estimate parameter values for services per provider or per geographic region. The query results can include a comparison of parameter values per provider or geographic region. For example, the query results can indicate a comparable doctor that charges less for a queried service. The platform 10 includes components such as a self-service server 12, client devices 14, and services-related data sources 16, all interconnected over a network 18 such as the Internet.

The network 18 may include any combination of private, public, wired, or wireless portions. The data communicated over the network 18 may be encrypted or unencrypted at various locations or along different portions of the network 18. Each component of the platform 10 may include combinations of hardware and/or software to process data, perform functions, communicate over the network 18, and the like. For example, any component of the platform 10 may include a processor, memory or storage, a network transceiver, a display, operating system and application software (e.g., for providing a user interface), and the like. Other components, hardware, and/or software included in the platform 10 that would be well known to persons skilled in the art are not shown or discussed herein for brevity.

The client devices 14 can be used to interact with the platform 10. Examples of client devices 14 include smart phones (e.g., APPLE IPHONE, SAMSUNG GALAXY, NOKIA LUMINA), tablet computers (e.g., APPLE IPAD, SAMSUNG NOTE, AMAZON FIRE, MICROSOFT SURFACE), computers (e.g., APPLE MACBOOK, LENOVO 440), and any other device that is capable of accessing data of the self-service server 12 over the network 18. In some embodiments, the client devices 14 can automatically estimate a geographic location for a query submitted to the self-service server. For example, a client device may include a global positioning system (GPS) receiver that receives positioning signals used to estimate the geographic location of the client device. The estimated geographic location can be submitted with a query to influence the query results based on the location of the client device. For example, the query results may include parameter values for the geographic region in which the client device 14 is located.

The self-service server 12 may include any number of server computers that operate to estimate parameter values for services based on service episodes on a per provider basis. The self-service server 12 may operate to collect data from various sources such as the services-related data sources 16 and the client devices 14. The data is synthesized to formulate models for service episodes that are used to estimate parameter values for queried services received from users.

The self-service server 12 can store models for the service episodes. In response to a query regarding a service, the self-service server 12 can generate an estimated query results. For example, healthcare service providers can provide provider-patient and provider-provider data to the self-service server 12. The data retrieved from the healthcare service providers is used to model episodes of care that can be used to estimate the costs of a queried procedure. The query results related to a service can be sorted per provider including an estimated parameter value for the queried service. In some embodiments, a user can constrain the scope of the query results. For example, the query results may include an estimate of specific payout from individual healthcare insurers for a given procedure within a specific timeframe.

In some embodiments, the self-service server 12 can establish a direct connection between the client device 14 and services-related data sources 16 based on the query results. For example, the query results may include a provider in a particular region that can provide a queried service. The user can request a direct connection to the provider over a variety of channels such as a web channel or voice channel. The data input by the user to query the self-service server 12 may be automatically provided to the provider upon establishing the direct connection so that the provider is granted context information that allows the user to seamlessly continue querying the provider for more information. Accordingly, data about providers or services can be provided by the services-related data sources 16 over the network 18 directly to the client devices 14 or indirectly through the self-service server 12.

The services-related data sources 16 may include any number of servers or other computing resources that can collect, store, and/or provide healthcare-related information to the self-service server 12 over the network 18. The services-related data sources 16 may include any source of healthcare-related information. For example, the services-related data sources 16 may include any providers such as medical facilities, private offices, or devices administered by healthcare professionals. In some embodiments, the services-related data may include at least portions of medical records utilized for estimating parameter value on queried services. For example, the medical records information may include provider-patient interactions or provider-provider interactions for estimating the cost of a procedure and estimating a specific payout from individual healthcare insurers for the given procedure.

The self-service server 12 may administer a self-service portal that allows users to access information related to the providers, services, and parameters thereof (e.g., costs associated with healthcare procedures). Examples of a portal include a website, mobile application (app), or any channels for providing information about service parameters to the client devices 14. For example, the client devices 14 can access, filter, and sort information about providers, insurers, and cost-estimation services through the portal provided by the self-service server 12.

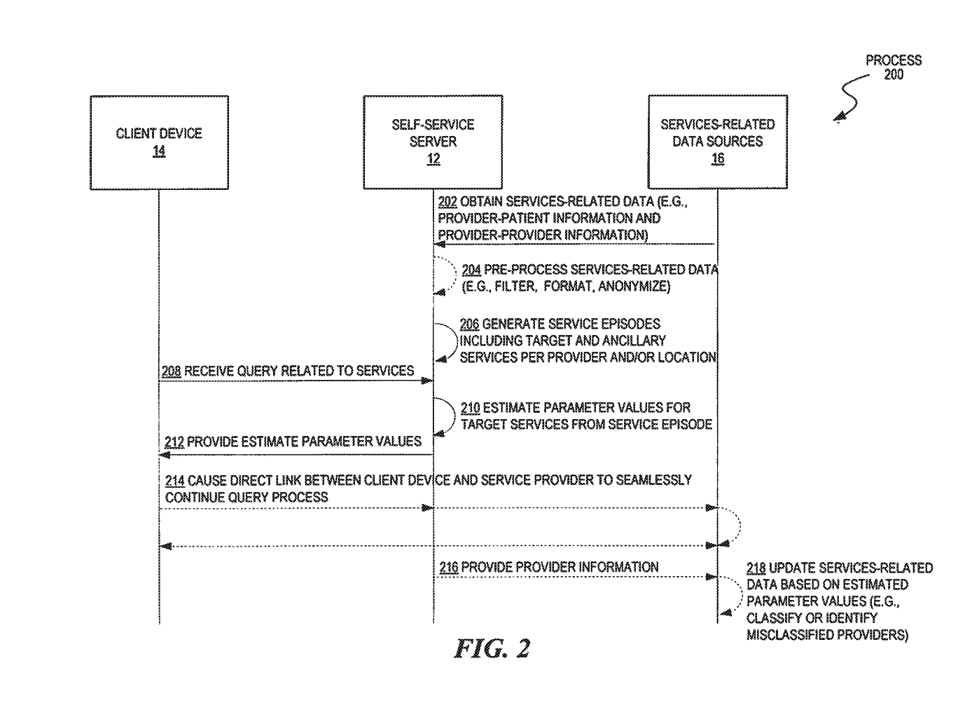

FIG. 2 is a sequence diagram that illustrates a process 200 for estimating parameter values for a service in response to a query for the service. For example, the self-service server 12 can estimate a cost (parameter value) for a procedure (service) at the healthcare provider level and/or estimate a specific payout from individual healthcare insurers for the given procedure.

In step 202, the self-service server 12 obtains services-related data from the services-related data sources 16. In some embodiments, the services-related data may include content of healthcare-related records (e.g., medical records or insurance claims). In some embodiments, the content of each healthcare-related record is incomplete or unavailable. The services-related data may include data about provider-patient interactions (e.g., included in insurance claim records) or provider-provider interactions (e.g., included in payment information by an insurer to a provider).

Provider-patient interactions data may include insurance claim records that include information including a description of the patient, the patient's condition for which services were provided, the services provided, and the cost of the services, as derived from an EDI 837 Health Care Claim transaction set or another HIPAA-compliant transaction set. For example, claims records may include procedure codes for procedures performed on a patient, the patient's age, sex, geographic location (e.g., city and/or state), start-of-service date, start-of-claim date, procedure cost, and the like.

Provider-provider interactions data may include insurance payment records including a provider's name, specialty, practice group, facility where service was rendered, and geographic location (e.g., city, state); insurer, procedure code, start-of-claim date; parameters on allowable amounts payable by the insurer for a given procedure code. For instance, payment records may indicate whether payments were made, reduced, or denied for a particular procedure code; whether there was a deductible, co-insurance, copay, etc.; any bundling or splitting of claims or line items; and indicate how the payment was made, such as through a clearinghouse, as derived from an EDI 835 Health Care Payment/Advice transaction set or another HIPAA-compliant set of transactions. In some embodiments, the services-related data may include providers that rendered services and providers that referred patients to receive services from the rendering provider.

In step 204, given that services-related data may be incomplete or fragmented, the self-service server 12 may pre-process the services-related data by removing extraneous data and transforming remaining data to a common format to generate service episodes. In some embodiments, the self-service server 12 may extract procedure codes from claim records and payment records. The self-service server 12 may also extract data indicative of geographic locations associated with procedure codes, which could indicate locations where procedures were provisioned. In some embodiments, the services-related data is pre-processed to anonymize any patient identifying information such as patient names. In some embodiments, the payment records are pre-processed to remove clerical errors, outlier values exceeding a threshold amount, and extraneous information. In some cases, the self-service server 12 may fill any missing data of the services-related data via extrapolation.

In step 206, the self-service server 12 generates models for service episodes. A service episode includes a target service code and ancillary service codes. An ancillary service code may be determined based on the proximity of an ancillary service to a target service. In some embodiments, a temporal proximity can be used to define an ancillary service. For example, an ancillary service code may be included in the same claim form as a target service code or included in a claim dated within a threshold time period before, during, or after the date of the claim record including the target procedure code. The frequency of any ancillary service codes associated with a target service code can be normalized per instance of target service code or across all target service codes for the service episode. In some embodiments, a service episode model can be updated using machine learning techniques based on services-related data subsequently obtained from the services-related data sources 16 and/or input from client device 14.

The relationships in provider-patient interaction data and provider-provider interactions data are incomplete. For example, a particular provider-provider record does not indicate a relationship with other providers. For example, a payments record may not indicate if there is a preexisting relationship between providers and does not indicate preexisting relationships between other providers (e.g., whether a service provider accepts a different insurance provider for services rendered to a patient). In some embodiments, a preexisting relationship can be determined when an insurance provider has paid another provider for services a number of times greater than a threshold amount. Hence, the service provider is said to likely accept the insurance provider's insurance plan. In some instances, the absence of this information is deliberate to prevent competition, or is simply because it is not available. As a result, there is no uniform source of data that can be queried to aid users in making informed decisions about services.

In some embodiments, a service episode is an “episode of care” that includes a target service and related services (e.g., ancillary services). For every patient that received the target service, all services occurring within a service window of x days before and after the date of the target service, where x is a predefined non-negative number, can be collected to define a scope of all services ancillary to the target service (e.g., anesthesia, lab work, revenue codes). For example, the service window may be 0 or 1 days. A raw proportion of patients in the claims data who received at least one particular service in the defined service episode is computed for each individual service in the defined service episode. A primary service provider responsible for initiating a target service, and in turn the resulting service episode, can then be determined.

A primary service provider may be highly ranked in a particular specialty of ranked lists of specialties used to identify specialties of service providers. In some embodiments, the primary service provider is the first provider who attended to a patient and whose specialty is the highest-ranked specialty on the ranked list of all services providers that attended the patient. A primary service provider may be identified among all eligible service providers involved in a service who has the highest-ranked specialty on a list. In some embodiments, the service provider that performed the most services related to a target service is defined as the primary service provider. In some embodiments, where all service providers that attended to a patient are ineligible as a primary service provider, the service provider that performed the greatest number of services for that particular patient is defined as the primary service provider.

In some embodiments, a combination of steps performed by the self-service server 12 defines an estimated parameter value of all services of an episode of care, which generates a reference for service parameter values specific to a particular insurance provider. In some embodiments, a parameter value reference is determined from provider-provider data by clustering insurance payments at aggregation levels. The data may be an incomplete set and/or biased sample. Many services included of a service episode may lack observations for a combination of service provider and insurance provider.

In step 208, the self-service server 12 receives a query from the client device 14. The query may include a target service and attributes such as a geographic location. The geographic location may be estimated by a GPS feature of the client device 14 or input by a user of the client device 14. For example, a user of the client device 14 may request assistance from the self-service server 12 in choosing a service provider and may narrow the query results to a specific insurance provider or within a specific geographical region. In some embodiments, the query can include conditions such as a provider that has performed the greatest number of a target service in a particular geographic region relative to other service providers in that geographic region.

In step 210, the self-service server 12 estimates a parameter value for a target service based on a service episode that includes the target service code and ancillary service codes. In some embodiments, the query results are constrained and/or sorted by provider and/or geographic region. The self-service server 12 can estimate a parameter value for a target service based on all the services of a service episode at different aggregation levels (e.g., from most geographically specific to least geographically specific). In some embodiments, the self-service server 12 may also estimate parameter values of all services in a service episode per insurance provider or across all insurance providers.

In some embodiments, the self-service server 12 uses one or more levels of aggregation. At a first level, a median parameter value for each combination of service provider and insurance provider is determined. At a second level, a median parameter value for each combination of service provider's practice group and insurance provider is determined. At a third level, a median parameter value for each combination of insurance provider and city is determined. At a fourth level, a median parameter value for each combination of insurance provider and state is determined. At a fifth level, a median parameter value for each combination of insurance provider on a nationwide basis is determined.

In some embodiments, for each service of a service episode, a parameter value is determined on the basis of the estimated parameter values of the aggregation levels. If at least one combination of insurance provider and service provider lacks a median parameter value, the self-service server 12 can impute a parameter value from an appropriate level of aggregation when parameter value information is available. The imputed parameter value may be estimated with an algorithm to find and choose a condition for which a parameter value exists in accordance with the following list.

(1) An exact match for service provider and insurance provider: compute a median parameter value for this combination matched in the parameter value reference, assign to every patient that received the service according to provider-patient data, and use the median parameter value computed across all of the patients.

(2) An exact match for insurance provider and practice group provider: compute a median parameter value for this combination matched in the parameter value reference, assign to every patient that received the service according to provider-patient data, and use the median parameter value computed across all the patients.

(3) Only service provider matches: compute a median parameter value for all insurance providers having preexisting relationships with the service provider (e.g., paid the service provider), assign to every patient that received the service according to provider-patient data, and use the median parameter value computed across all the patients.

(4) Only practice group provider matches: compute a median parameter value for all insurance providers having preexisting relationships with practice group provider (e.g., paid the practice group provider), assign to every patient that received the service according to provider-patient data, and use the median parameter value computed across all the patients.

(5) Only insurance providers and city matches: compute a median parameter value for all payments made by a specific insurance provider in a provider's city, assign to every patient that received the service according to claims records, and use the median parameter value computed across all of these patients.

(6) Only state and insurance provider matches: compute a median parameter value for all provider-provider records by a specific insurance provider in the provider's state.

(7) Only city matches: compute a median parameter value paid among all insurance providers represented in the provider's city.

(8) Only state matches: compute a median parameter value among all insurance providers represented in the provider's state.

(9) Only insurance provider matches: compute a median parameter value for all provider-provider records nationally by a specific insurance provider.

(10) No match: compute a median parameter value nationally among all insurance providers.

In some embodiments, the self-service server 12 performs the combination of steps required to generate an estimated parameter value for a target service. In some embodiments, the process for estimating parameter values for services involves using weighted scores applied to the provider-patient data and provider-provider data. In some embodiments, the weights can be automatically adjusted based on machine learning techniques that improve the accuracy of the weights over time.

For example, a training dataset of known attributions can be input into a machine learning algorithm. Provider-patient information with unknown variables or values can be input into the machine learning algorithm to generate estimates for the variables or values. In some embodiments, an expert can verify whether the estimates are correct to assist the machine learning algorithm in making future estimates. After an initial training period, the machine learning algorithm may yield variable or parameter estimates with sufficient accuracy such that it could be applied to reliably estimate unknown variables or values. The machine learning algorithm could continue to iteratively refine or adjust the value of weights applied during the estimation process over time.

In some embodiments, an estimated parameter value for a service episode corresponds to the sum of all parameter values of all service codes of the service episode. The parameter value for each service is calculated by multiplying the particular service's parameter value by the expected frequency for a patient to receive that service with which they occur among a patient population in the provider-provider information. For example, if 50% of patients who receive an colonoscopy also receive a biopsy as part of an episode of care, and the un-weighted price of the biopsy is $100, then the expected price reflected in the estimate would be $50.

In some embodiments, there are two types of weights: national proportion and provider proportion. National proportion is the proportion of patients who received a particular service of respective service episodes across all nationally collected services-related data. Provider proportion is the proportion of patients who received a particular service as part of their service episodes at an individual provider level indicated in the services-related data. In the above colonoscopy example, the expected frequency for each service is calculated by weighting the provider proportion by the number of patients that the service provider treated and weighting a frequency of the patient population level frequencies by $50. If a large number of observations for an individual service provider is provided, the weight tends to reflect the individual service provider proportion. If insufficient service provider information is provided, the weight tends to bias toward the national proportion.

In some embodiments, the weights may require manual adjustments to account for systematic bias in provider-provider information, among other inherent noise/bias. For these weights to be manually adjusted, each service in a service episode may be manually curated or predefined into distinct groups (e.g., buckets). Each bucket contains a set of service codes which denote the set of ancillary services a patient usually receives when a patient receives a target service. For instance, patients generally receive anesthesia when receiving a colonoscopy. The frequencies of each service are conditioned on receiving at least one service in the bucket. For example, among all patients who received an IUD insertion procedure, only 80% of episodes may include a code for the specific brand of IUD. An assumption is made that every IUD insertion service code must have an associated code designating the IUD brand, so the associated code for the IUD brand is weighted in a bucket separate from the insertion code. Separating the IUD brand and the insertion code in this way adjusts the weight of the IUD brand to 100%.

In some embodiments, the services that are manually curated and grouped into buckets may undergo an administratively controlled review process for quality assurance to ensure that the grouping logic is sound and that the estimated parameter value is representative of a typical service episode that a patient likely experiences. This review process may involve an external medical coding expert. This process may also serve a secondary purpose of ensuring the appropriateness of a service episode across all service providers so that reasonable comparisons are made by the user.

To estimate a parameter value for a service episode of a target service for a particular service provider, the process may involve performing a sum across expected parameter values of each individual service included in the service episode. Each service's expected parameter value is calculated by multiplying the un-weighted service's parameter value by the expected frequency for a patient to receive that service. To calculate the expected frequency, the service provider proportion must be weighted by the number of patients they treated. This process of weighting is repeated for every provider in the database.

The level of imputation used for each service of service episode may be tracked and assigned a value, for example, between 1 and 10, corresponding with steps in the list of conditions above. The parameter value-weighted average of the imputation levels for each service may be calculated and assigned to each primary service provider as an imputation score to track the quality of parameter value estimates. A lower imputation score for a given service provider-insurance provider combination corresponds to a higher amount of data (in general) for the service provider-insurance provider combination. Any estimated parameter values of primary service providers for services with an imputation score larger than a threshold may be hidden from users.

In step 212, the self-service server 12 responds to the received query by providing information indicative of a parameter value and suitable service providers. For example, the self-service server 12 may provide query results via a website or software application resident on the client device 14. The query results may be displayed as a list of matching service providers ranked by match strength relative to the target service, and other attributes such as geographic region or insurance provider, and/or information comparing matching service providers to each other, or statistics for service providers. In some embodiments, a profile of a particular service provider can be requested via the client device 14. The profile may include an estimate parameter value for a target service provisioned by the selected service provider and provide insights into insurance provider payouts for the target service, such as a net parameter value for a target service provisioned by that service provider.

In step 214, the self-service server 12 may cause a communications link to be established between the client device 14 and a selected provider identified in the query results. For example, the user of the client device 14 can click on a telephone icon of a service provider included in the query results. In response, the self-service server 12 can initiate a voice communications channel directly between the client device 14 and the service provider of the services-related data sources 16. In some embodiments, the information input by the user to obtain query results is made available to the service provider such that the user can continue a query process directly without needing to provide the same information to the selected provider. This avoids the need for the user to re-identify himself/herself or provide context information.

In step 216, the services-related data sources 16 can obtain data from the self-service server 12 about the identified service providers. The obtained information may be used to classify or re-classify service providers by specialty based on services that they provide most often or insurance providers most often accepted. Lastly, in step 218, the services-related data sources 16 can update its data to reflect newly determined information about the identified service providers. As such, the services-related data sources 16 can classify, identify misclassified, and/or re-classify service providers based on their estimated parameter values.

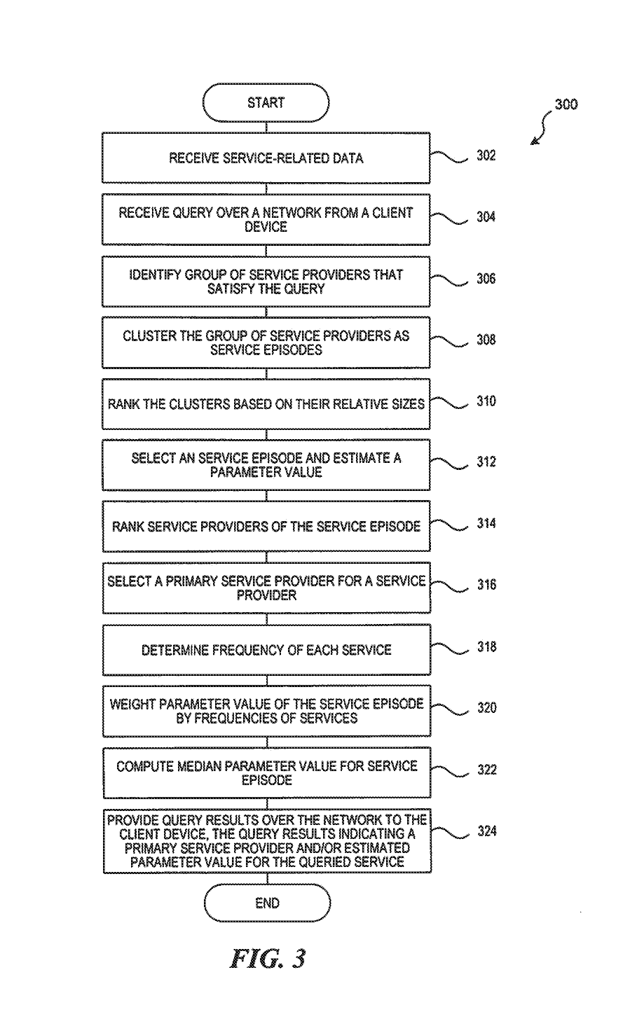

FIG. 3 is a flowchart illustrating a process 300 of estimating parameter values for services according to some embodiments of the present disclosure. In step 302, the self-service server 12 can receive services-related data including provider-patient data and provider-provider data. The services-related data identifies service providers, descriptions of services provisioned during a time period, and attribute values for the service providers. The services-related data also includes indications of patients associated with descriptions for services provisioned during a time period, and attribute values for the patients including, for example, a parameter value for a service.

In step 304, the self-service server 12 receives a query over a computer network 18 from the client device 14. For example, the self-service server 12 can administer a self-service portal that can display on the client device 14 for a user to interact with the self-service server 12 to submit queries for estimated parameters of services. In some embodiments, the received query defines a target service and attributes that constrain the query process (e.g., geographic region, insurance provider).

In step 306, the self-service server 12 identifies a group of service providers that satisfy the received query. The group of service providers are identified as being associated with the target service and having at least some attributes that match those attributes that constrain the query.

In step 308, the self-service server 12 divides the group of service providers into clusters that define service episodes. A cluster is defined by mutually-shared services associated with service providers. In step 310, the clusters are ranked based on their relative sizes. In step 312, the self-service server 12 selects a cluster by rank as a service episode and generates an estimated parameter value for the service episode.

In step 314, the self-service server 12 ranks each service provider of a service episode based on the attributes of the service provider that match the target service. In step 316, the self-service server 12 selects a primary service provider for each service episode. A primary service provider may be defined as the service provider that is ranked the highest for a particular service episode. In step 318, the self-service server 12 determines a frequency of each service across all patients.

In step 320, the self-service server 12 weighs a parameter value for each service of a service episode depending on how often that service was provisioned. For example, the self-service server 12 can weigh the parameter value of each service across the patients by multiplying its frequency by the parameter value of the service. In step 322, the self-service server 12 computes a median parameter value for a service episode by summing each weighted parameter value of the services represented in the service episode. In step 324, the self-service server 12 can return query results to the client device 14 including the primary service provider and/or a parameter value of the service episode. The query results can be transmitted over the computer network 18 back to the client device 12. The self-service server 12 may cause the client device 14 to display the query results or generate a visualization derived from the query results.

It is to be understood that FIG. 2 or 3 show example processes of the self-service platform 10. However, other processes may achieve the same or similar outcomes with fewer or additional steps not shown in FIG. 2 or 3. Moreover, the steps shown in FIG. 2 or 3 may be performed in a different order.

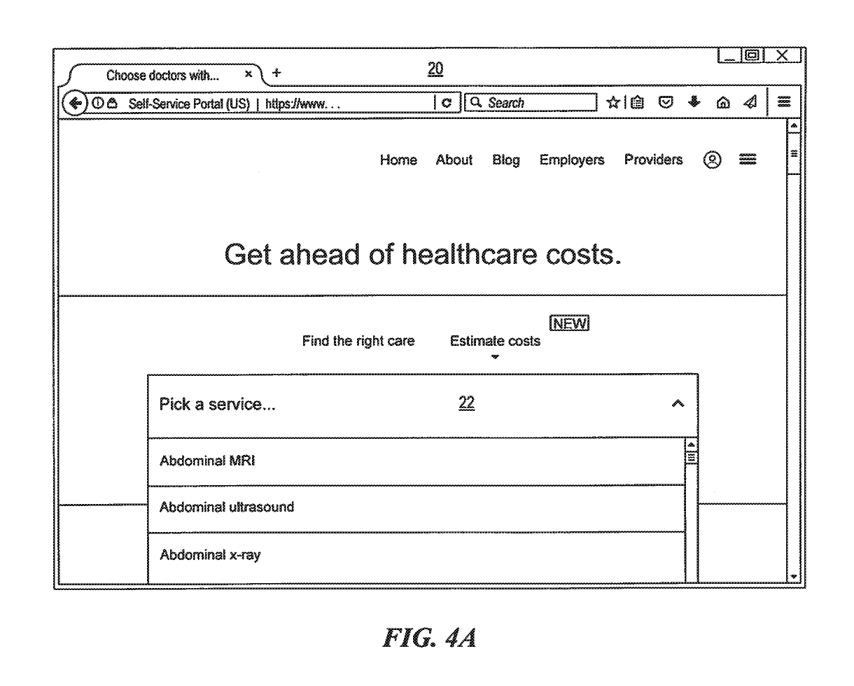

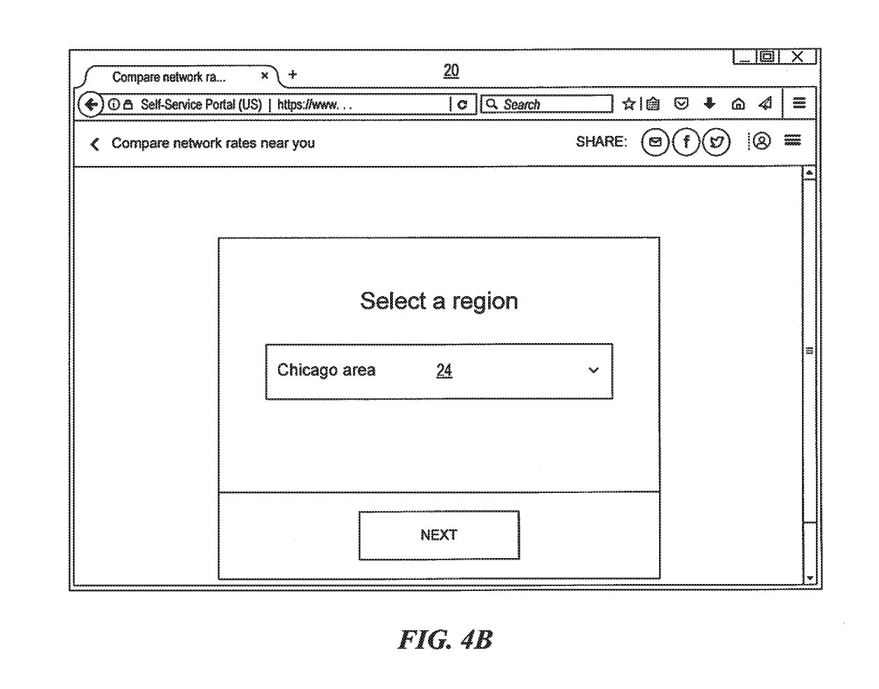

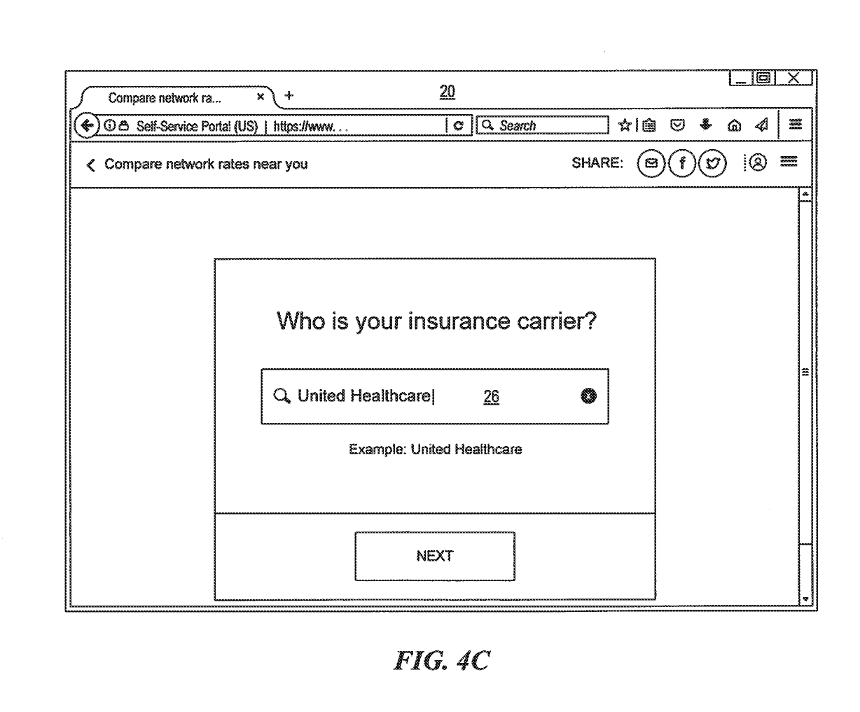

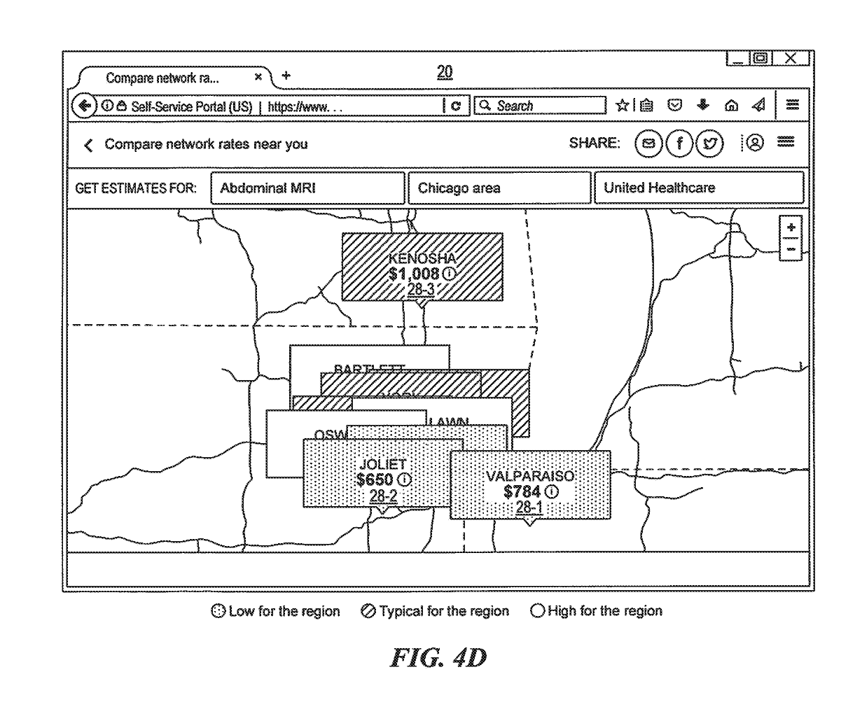

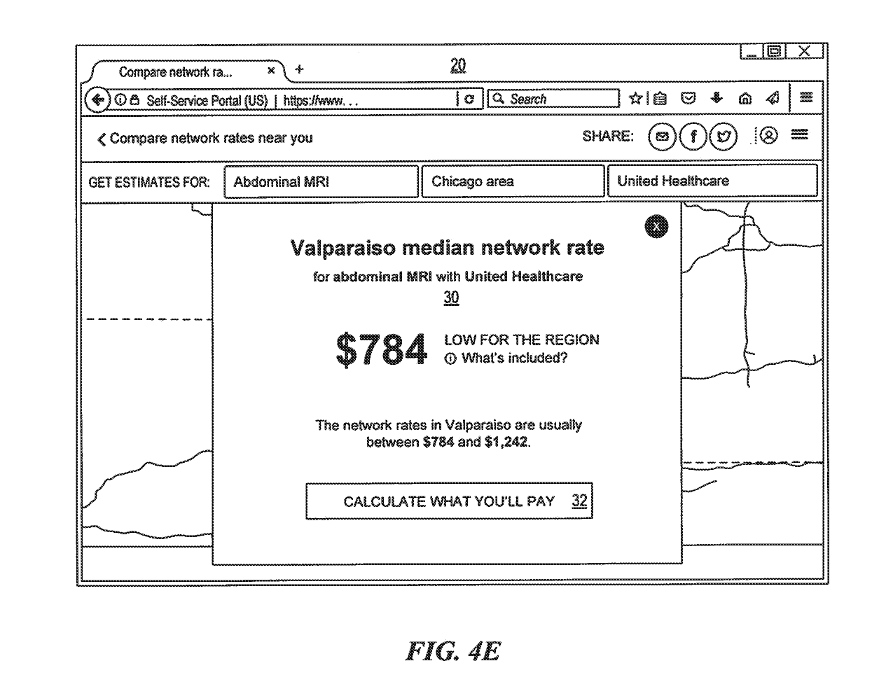

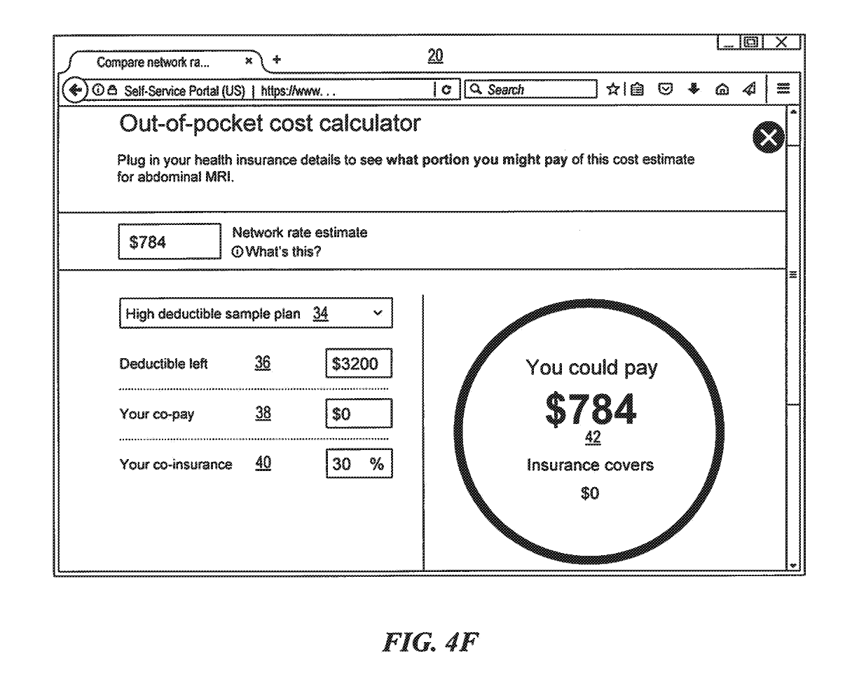

FIG. 4A illustrates a self-service portal used to query estimate parameter values for a target service according to some embodiments of the present disclosure. The web browser 20 is rendering a graphical user interface (GUI) of the self-service portal. The self-service portal includes a text box 22 that can receive user input defining a target service. As shown, a dropdown list includes selectable services. Upon receiving an input selecting a service, other GUI views can be rendered by the web browser 20.

The GUI views may prompt a user to input constraints used to accurately estimate parameter values. The constraints may include a geographic location or region, insurance provider, and the like. For example, FIG. 4B illustrates a GUI view used to constrain a query for estimate parameter values of target services to a particular geographical region according to some embodiments of the present disclosure. As shown, a selected geographic region can be input by a user into the text box 24. FIG. 4C illustrates a GUI view used to further constrain the query for estimate parameter values of the target service to a particular insurance provider according to some embodiments of the present disclosure. The text box 26 can receive user input of the insurance provider.

After the selected target service and constraints have been input, the self-service server 12 can cause display of a GUI view including estimate parameter values. For example, FIG. 4D illustrates a GUI view showing estimate costs for a particular service within a particular region covered by a particular insurance provider according to some embodiments of the present disclosure. As shown, insurer specific boxes 28 are displayed to overlay a geographic map of the selected geographic region. Each of the boxes 28 can be colored different to indicate whether estimated parameter values of particular boxes 28 are relatively low, typical, or high for the geographic region. Any of the parameter value estimate boxes 28 can be selected to reveal detailed estimate data for a particular insurance provider in a particular geographic region.

For example, FIG. 4E illustrates a GUI view showing data for a particular insurance provider in the particular geographic region according to some embodiments of the present disclosure. The display of FIG. 4E can be generated in response to a selected the estimate box 28-1. As shown, a window 30 includes the Valparaiso (service provider) median network rate for an abdominal MRI (target service) with United healthcare (insurance provider) estimated at $784 (parameter value). The user can also click an option 32 to calculate what the user is estimated to need to pay for this target medical service.

For example, FIG. 4F illustrates a GUI view showing data for a personalized calculation of an estimated parameter according to some embodiments of the present disclosure. The web browser 20 renders a window including customizable features for personalizing the network rate estimate for the particular user. As shown, these features include a plan type 34, deductible left 36, co-pay amount 38, and percentage covered by a co-insurance 40. The calculated personal costs estimates are rendered in a visualization 42 after the user has customized the aforementioned options.

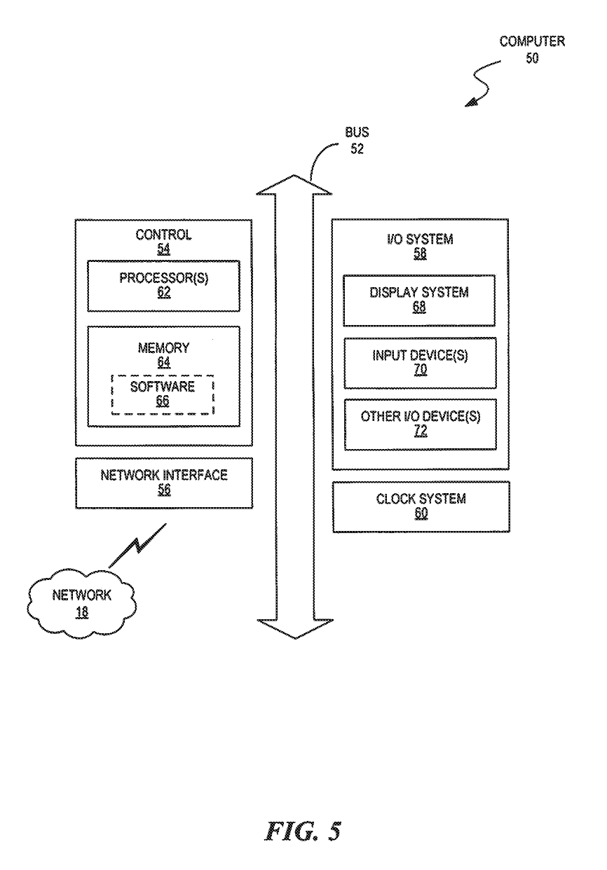

FIG. 5 is a block diagram of a computer 50 operable to implement the disclosed technology according to some embodiments of the present disclosure. The computer 50 may be a generic computer or specifically designed to carry out features of platform 10. For example, the computer 50 may be a system-on-chip (SOC), a single-board computer (SBC) system, a desktop or laptop computer, a kiosk, a mainframe, a mesh of computer systems, a handheld mobile device, or combinations thereof.

The computer 50 may be a standalone device or part of a distributed system that spans multiple networks, locations, machines, or combinations thereof. In some embodiments, the computer 50 operates as a server computer (e.g., the self-service server 12 or services-related data sources 16) or a client device (e.g., client devices 14) in a client-server network environment, or as a peer machine in a peer-to-peer system. In some embodiments, the computer 50 may perform steps of the disclosed embodiments in real time, near real time, offline, by batch processing, or combinations thereof.

As shown in FIG. 5, the computer 50 includes a bus 52 that is operable to transfer data between hardware components. These components include a control 54 (e.g., processing system), a network interface 56, an input/output (I/O) system 58, and a clock system 60. The computer 50 may include other components that are not shown nor further discussed for the sake of brevity. One having ordinary skill in the art will understand any hardware and software that is included but not shown in FIG. 5.

The control 54 includes one or more processors 62 (e.g., central processing units (CPUs)), application-specific integrated circuits (ASICs), and/or field-programmable gate arrays (FPGAs), and memory 64 (which may include software 66). For example, the memory 64 may include volatile memory, such as random-access memory (RAM), and/or non-volatile memory, such as read-only memory (ROM). The memory 64 can be local, remote, or distributed.

A software program (e.g., software 66), when referred to as “implemented in a computer-readable storage medium,” includes computer-readable instructions stored in the memory (e.g., memory 64). A processor (e.g., processor 62) is “configured to execute a software program” when at least one value associated with the software program is stored in a register that is readable by the processor. In some embodiments, routines executed to implement the disclosed embodiments may be implemented as part of an operating system (OS) software (e.g., MICROSOFT WINDOWS, LINUX) or a specific software application, component, program, object, module, or sequence of instructions referred to as “computer programs.”

As such, the computer programs typically comprise one or more instructions set at various times in various memory devices of a computer (e.g., computer 50), which, when read and executed by at least one processor (e.g., processor 62), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 64).

The network interface 56 may include a modem or other interfaces (not shown) for coupling the computer 50 to other computers over the network 18. The I/O system 58 may operate to control various I/O devices, including peripheral devices, such as a display system 68 (e.g., a monitor or touch-sensitive display) and one or more input devices 70 (e.g., a keyboard and/or pointing device). Other I/O devices 72 may include, for example, a disk drive, printer, scanner, or the like. Lastly, the clock system 60 controls a timer for use by the disclosed embodiments.

Operation of a memory device (e.g., memory 64), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

From the foregoing, it will be appreciated that specific embodiments of the invention have been described herein for purposes of illustration, but that various modifications may be made without deviating from the scope of the invention. Accordingly, the invention is not limited except as by the appended claims.

1. A self-service server computer comprising:
a processor;
memory including instructions executable by the processor causing the server computer to:
obtain, over a computer network, provider-patient data of interactions between a plurality of providers and a plurality of patients;
obtain, over the computer network, provider-provider data of interactions between a plurality of service providers and a plurality of insurance providers;
pre-process the obtained provider-patient data and provider-provider data to extract a plurality of service codes and parameter values associated with the plurality of service codes;
generate a service episode including a target service and a plurality of ancillary services, the service episode having a parameter value estimated from a parameter value of a service code for the target service and a plurality of parameter values of a plurality of service codes for the plurality of ancillary services; and
return the estimated parameter value of the service episode in response to a query for an parameter value of the target service such that the estimated parameter value is a proxy for the parameter value for the target service when the self-service server computer is queried for the target service.

2. The self-service server computer of claim 1, wherein the query defines the target service and a plurality of attributes that constraint to the query results.

3. The self-service server computer of claim 2, wherein the plurality of attributes includes a geographic region where the target service could be provisioned.

4. The self-service server computer of claim 2, wherein the plurality of attributes includes a service provider for the target service.

5. The self-service server computer of claim 2, wherein the plurality of attributes includes a geographic region where the target service could be provisioned and a service provider for the target service.

6. The self-service server computer of claim 1 further caused to:
return a plurality of estimate parameter values for a respective plurality of service providers that can each provision the target service.

7. The self-service server computer of claim 6, wherein the plurality of service providers are ranked based on a relative frequency with which a service provider provisions the target service compared to other service providers.

8. The self-service server computer of claim 1 further caused to, prior to receiving the query:
cause display of a graphical user interface on the display of the client device including a plurality of graphical controls enabling a user of the client device to define the target service, a geographic region where the target service is to be provisioned, an and insurance provider such that the estimated parameter for the target service is constrained by at least one of the geographic region or the insurance provider.

9. The self-service server computer of claim 8 further caused to:
cause display of the graphical user interface on the display of the client device to render a plurality of estimated parameter values and respective plurality of service providers overlaying a geographic map defined by the user such that each estimate parameter value is presented on a location of the geographic map where a corresponding service provider is located.

10. The self-service server computer of claim 9 further caused to:
cause display of the graphical user interface on the display of the client device including a plurality of graphical controls enabling a user to personalize an estimated parameter value.

11. The self-service server computer of claim 1 further caused to:
receive, over the computer network, a request from the client device to contact the service provider; and
cause a direct communications link between the client device and a device of the requested service provider such that the communications link provides a seamless continuation of the query.

12. The self-service server computer of claim 1, wherein the provider-patient data of interactions are included in insurance claims records.

13. The self-service server computer of claim 12, wherein the provider-provider data of interactions are included in payment records indicating payments of insurance providers to service providers.

14. The self-service server computer of claim 1, wherein to pre-process the obtained provider-patient data and provider-provider data comprises anonymizing any data from which a patient can be identified.

15. The self-service server computer of claim 1, wherein a parameter value is a cost and a target service is a medical service for a patient.

16. The self-service server computer of claim 1, wherein an ancillary service is defined as a service provisioned within a threshold time period relative to a point in time when a target service was provisioned.

17. A method for estimating a parameter value for a target service, the method performed by a server computer having a processor and memory, the method comprising:
receiving, over a computer network, provider-patient interactions data and provider-provider interactions data including:
for each of a plurality of service providers, a description of a provisioned service and at least one attribute, and
for each of a plurality of patients, a description of a provisioned service and at least one attribute including a parameter value for the service; and
receiving, over the computer network from a client device, a query including at least one attribute for a service provider or a patient and a target service;
identifying a group of service providers that satisfy the received query, the group of service providers being selected from among the plurality of service providers having an attribute that matches the queried attribute and having provisioned a service matching the target service;
dividing the group of service providers into a plurality of clusters each having a common service provided by the group of service providers;
ranking the plurality of clusters based on their relative sizes;
selecting a cluster of the plurality of ranked clusters as a service episode;
generating an estimated parameter value for the service episode;
ranking each service provider of the service episode based on a frequency that each service provider provisioned a target service or an ancillary service;
selecting a primary service provider for the service episode, the primary service provider being the highest ranked service provider;
determining a frequency for each service across the plurality of patients;
weighting a parameter value for each service of the service episode across the plurality of patients; and
computing a median parameter value for the service episode by summing each weighted parameter value for each service of the service episode; and
causing display of information indicative of the primary service provider and the parameter value of the service episode on a display of the client device.

18. The method of claim 17, wherein a description for the service includes a time when the service was provisioned and an attribute includes a timeframe.

19. The method of claim 17, wherein an attribute includes an allowable amount payable by an insurance provider for a service, the method further comprising:
weighting an allowable amount payable by an insurance provider for service of the service episode across the plurality of patients by multiplying a frequency associated with each service with the allowable amount payable by the insurance provider for a service;
computing a median payout for the service episode by summing each weighted allowable amount payable by an insurance provider for a service of the service episode;
computing a net price for the service episode by subtracting the median payout from the median price for the service episode; and
transmitting, to the client device, information indicative of the net price of the service episode for display on a user interface displayed on the client device.

20. The method of claim 17, further comprising, prior to dividing the group of service providers into a plurality of clusters:
removing any data from the provider-patient interactions data and provider-provider interactions data that is extraneous to determining an estimate parameter value for a target service.
